(19) United States
(12) Patent Application Publication
(10) Pub. No.: US 2013/0103669 A1
(43) Pub. Date: Apr. 25, 2013

(54) Search Engine Indexing

(71) Applicant: International Business Machine Corporation, Armonk, NY (US)

(72) Inventors: Zamir G. Gonzalez, Durham, NC (US); Michael Kelly, Ewen, NY (US); Thomas E. Murphy, JR., Hopewell Junction, NY (US); Mordechai Nisenson, Haifa (IL)

(73) Assignee: INTERNATIONAL BUSINESS MACHINE CORPORATION, Armonk, NY (US)

(21) Appl. No.: 13/713,765

(22) Filed: Dec. 13, 2012

Related U.S. Application Data
(63) Continuation of application No. 12/891,190, filed on Sep. 27, 2010.

(51) Int. Cl. G06F 17/30

(52) U.S. Cl. CPC G06F 17/30864
USPC 707/711

(57) ABSTRACT

Exemplary embodiments include a search engine indexing method, including finding a page on a server that includes keywords, scanning the page for a tag designating a portion of the page from which to index the keywords and in response to a presence of the tag within the page, indexing the portion of the page that is designated by the tag.

### CROSS-REFERENCE TO RELATED APPLICATION

This application is a continuation of U.S. patent application Ser. No. 12/891,190, filed Sep. 27, 2010, the disclosure of which is incorporated by reference herein in its entirety.

### BACKGROUND

The present invention relates to web crawlers and search engines, and more specifically, to methods, systems and computer program products for search engine indexing implementing tags that determine which section of a page to search for search terms.

As the content of the internet continues to grow it has become difficult for search engines to cache/index all this information. The average webpage size has more than tripled from 2003 to 2008 and many of the largest search engines such as Google and Yahoo limit how much of a webpage is considered for indexing. In addition, enterprise searching in the corporate sector requires intelligent data mining on its own artifacts, and similar search limitations occur. In addition, there is often personal information on sites or in files that content authors do not want stored in external indexes. Much of enterprise legacy data can be unstructured and not easy for search engines to parse for relevant portions. Currently, the Robots.txt file allows restriction of certain pages or extensions. In addition, the Sitemaps protocol allows a webmaster to inform search engines about URLs on a website that are available for crawling. A Sitemap is an XML file that lists the URLs for a site and allows webmasters to include additional information about each URL, such as when it was last updated, how often it changes, and how important it is in relation to other URLs in the site. As such, search engines can crawl the site more intelligently. Sitemaps are a URL inclusion protocol and complement robots.txt, which is a URL exclusion protocol. While current protocols such as Sitemaps and robots.txt aid in guiding search engines, current search queries are limited due to the volume of information on the Internet and enterprise data repositories that can result in extraordinarily long searches that yield false hits retrieved outside the realm of original search queries.

### SUMMARY

Exemplary embodiments include a search engine indexing method, including finding a page on a server that includes keywords, scanning the page for a tag designating a portion of the page from which to index the keywords and in response to a presence of the tag within the page, indexing the portion of the page that is designated by the tag.

Further exemplary embodiments include a web page generation method, including generating electronic content in the web page, identifying a portion of the electronic content to be indexed by a web crawler and designating the portion of the electronic content to be indexed by the web crawler with a header tag and a trailer tag, wherein the header tag and the trailer tag designate the portion of electronic content to be indexed by the web crawler.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a flow chart for a method of search engine indexing in accordance with exemplary embodiments;

FIG. 2 illustrates a file search structure;

FIG. 3 illustrates an example of a page on an Enterprise network;

FIG. 4 illustrates a screenshot of a search engine window;

FIG. 5 illustrates another screen shot of a search engine window; and

FIG. 6 illustrates an exemplary embodiment of a system in which the exemplary search engine indexing methods described herein can be implemented.

### DETAILED DESCRIPTION

In exemplary embodiments, the systems and methods described herein selectively index web page content, which is advantageously enabled with editorial markers, by authors or editors or administrators of the web pages such that tradeoffs in indexing storage, search response time and above all meaningful/focused results/hits are achieved. In exemplary embodiments, the systems and methods described herein enable authors of content to influence/assist search engines by tagging in the well understood Robots.txt and Sitemap protocol to define not only what pages to crawl, but also taking it a step further to identify where the relevant data occurs within those given pages, indexing only the content between “begin” (i.e., header) and “end” (i.e., trailer) flags based on a set of flags on the page. The exemplary tags therefore indicate where to start and stop crawling the page for relevant search terms, and ignoring other data.

The exemplary search engine indexing systems described herein can include a crawler and indexer operatively coupled to a search engine configured to receive search requests, wherein the crawler is configured to locate pages on the network and fetch them and the indexer is configured to index the page from the network in the search engine index so that the search engine may locate pages relevant to a search request containing keywords. The crawler may be further configured to fetch designated locations within a page from the network and not fetch other locations within the page. The indexer is further configured to index content appearing within designated locations of a page fetched from the network and not index certain content not appearing within designated locations on the page. Certain information, such as page metadata, may still be fetched and indexed even if it does not appear in a designated location. The combination of crawler and indexer together may be termed a “web-crawler”. It is understood that information indexed is searchable by the search engine, thus locating the information to be indexed is equivalent to locating the information to be made available for search.

Currently, typical search engines begin searching from the beginning of a page and search from byte 1 to byte N (N being an integer value typically N=1000). In exemplary embodiments, the author of the web content can insert the header and trailer tags within the page at a location that does not necessarily start at the beginning of the page. The author can also limit the number of bytes read by the crawler to some value less than the typical N. Since search engines generally limit the number of bytes read by the crawler, in exemplary embodiments, the author can place several tag pairs enabling the search engine to read multiple locations within the page with an upper limit of N. As such, the exemplary “start” and “stop” semaphores placed multiple times throughout the page significantly focuses the indexing and reduces the size of the index storage, allowing for faster and more efficient searches due to the reduced content within the index itself. In exemplary embodiments, the search engine includes instructions to enable the crawler first scan pages for the presence of tags within the page. If there are tags present in the page, the search engine indexes the data enclosed in the tags. As further described herein, the crawler can read in between multiple tag pairs. In exemplary embodiments, whether there is one tag pair or multiple tag pairs, the indexing can be controlled to some number of bytes less than the typical N bytes, conventionally read by search engines. If there are no tags present in the page, the page is indexed from the first byte up to the predetermined N bytes. Conversely, indexing can be turned off from the beginning with the simple inclusion of an indexing off tag.

As described herein, the exemplary systems and methods can be implemented in search engines on public networks such as the Internet. The exemplary systems and methods can also be implemented on private networks such as enterprise networks. As described herein, enterprise pages can be of a size that far exceeds the search limits of current search engines. In exemplary embodiments, the systems and methods described herein can selectively index specific sections within data repositories (e.g., well established hierarchical HTML frameworks and Lotus databases), both within the nodes as well as specifically within particular nodal pages, thereby reducing index storage and CPU search cycles during data mining runs.

Such an approach can be used to significantly reduce false-positive search hits when a searched keyword or phrase is used out of context. Using the indexing off/on tags, the false-positive indexing hits can be excluded from future search hits.

The exemplary systems and methods described herein enable owners of pages to disseminate the content that they consider to be the most relevant pieces indexed before search engines stop processing the data, especially if critical index material falls below the search engine's inherent indexing clip-limit. In exemplary embodiments, in the enterprise space, a similar Robots.txt/Sitemap implementation yields an interface between each data source or content management system and the indexing bot. Based on the set of flags on the page, only the content between the begin and end flags is indexed. Conversely, if there is, for example, a confidential section within a set of pages, the content owner can use the tagging mechanism to determine what to exclude. As such, the tags would indicate where to start and stop ignoring data. These “start” and “stop” semaphores can be invoked multiple times throughout the page, which can significantly focus the indexing and thus reduce the size of the index storage, allowing for faster and more (CPU-efficient) searches due to the reduced content within the index itself.

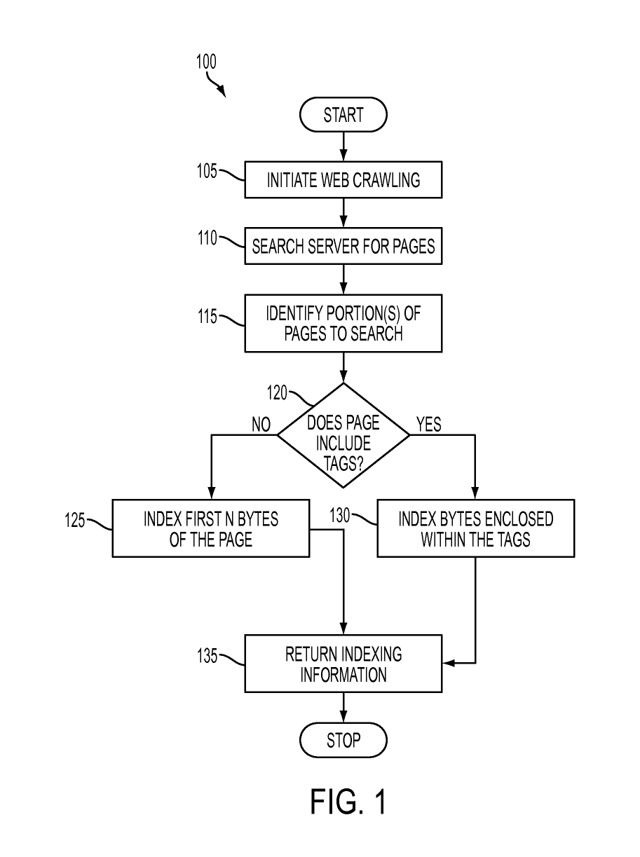

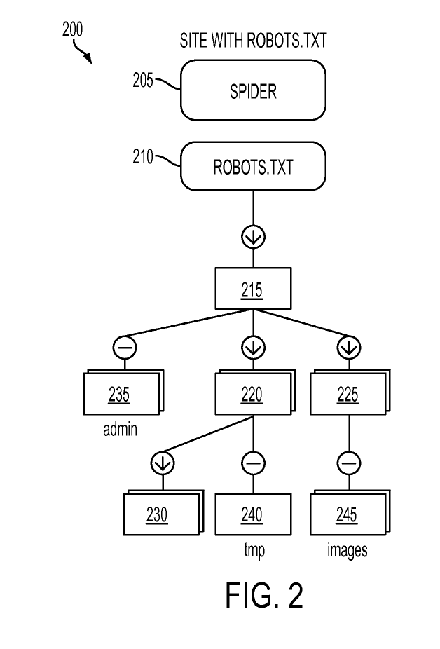

FIG. 1 illustrates a flow chart for a method 100 of search engine indexing in accordance with exemplary embodiments. As known in the art, the indexing is performed by a crawler as an ongoing background process. As described herein, once the crawler/indexer has built a table of keywords (influenced by an author/administrator's use of exemplary tags) and the associated URLs, a search engine can be implemented without modification and without awareness of the exemplary tags, and provide a user experience in which there is improvement in performance and inherently more accurate (i.e., less false hits) results. At block 105, the crawler initiates crawling of pages, searching the network (e.g., the Internet or Enterprise network) for servers that include searchable pages. At block 110, the crawler searches a particular server for searchable pages. At block 115, the crawler identifies portions of pages to be indexed in the search engine (made available for search). As described herein, well-know protocols such as Robots.txt describe which pages are excluded from indexing in the search engine. In addition, protocols such as Sitemaps are implemented to include pages for indexing in the search engine. Sitemaps does not guarantee that pages are included in search engines, but does provide hints for search engines. In exemplary embodiments, the exclusion/inclusion protocols can be modified to further include instructions indicating that particular pages on the server include tags that enclose the portions of the page(s) that authors have identified as pertinent portions of the page(s) that crawlers should index. For example, FIG. 2 illustrates a file search structure 200 in which a search engine crawler 205 reads a robots.txt file 210 to determine which pages 215, 220, 225, 230 the crawler 205 is permitted to index and which pages 235, 240, 245 the crawler 205 is prohibited to index. In exemplary embodiments, it is within pages 215, 220, 225, 230 that the crawler may encounter the exemplary tags and selectively index within those pages.

In exemplary embodiments, the crawler is encoded to be aware of the inclusion of tags, and if the protocols include tags, the crawler is aware to first scan the pages for the presence of tags. As such, at block 120, the crawler determines whether the page includes tags. In exemplary embodiments, the crawler includes instructions to first check that the page includes tags. For example, Robots.txt may include instructions to alert the crawler that the page includes tags. If the page does not include tags at block 120, then at block 125, the search engine indexes the first N bytes of the page as known in the art. If at block 120, the page does include tags, then at block 130, the crawler indexes the content enclosed in the tags. The content enclosed in the tags may be less than the predetermined clip limit, N bytes, of the search engine. In exemplary embodiments, the author may then select another portion of the page to enclose with a second pair of tags. In such a case, the crawler indexes the content within the second pairs of tags as well. If the number of bytes enclosed within the tags is less than the clip limit of N bytes, the author can further include other portions of the page within additional pairs of tags so long as the clip limit is maintained. The search engine continues to index between tag pairs until the clip limit is reached. It is appreciated that an end-indexing tag may not be included. Instead, the method can run to the end of the document from the header tag as long as a clip limit is not exhausted. In addition, the author may have selected to include a full N bytes within a single pair of tags. In exemplary embodiments, virtual tags may be specified, whereby a virtual tag is specified by giving an offset within a page, either a number of bytes, characters or lines, from the start of the page or from a previously defined location in the page, such as the previous virtual tag. The crawler may index the content between pairs of virtual tags as if the tags were actually present at the specified location in the page. The virtual tags may be specified in the page itself or in another file, such as Robots.txt.

Referring still to FIG. 1, whether the page includes tags or not at block 120, the crawler indexes the page either at block 125 or at block 130. At block 135, the crawler makes decisions based on the tags and returns the indexing information for future reference. It is appreciated that the method 100 continues on a particular server for as many pages as are identified as searchable by the protocols.

### Example

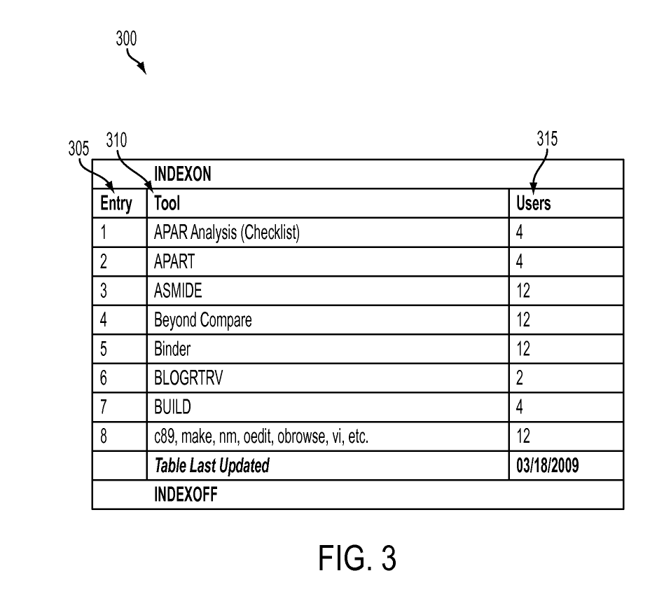

FIG. 3 illustrates a page 300 from a department operating manual (DOM) called MXTA in an Enterprise. The DOM includes entries 305, numbered 1-8 corresponding to a tool 310. In this example, the author created a tag pair within the manual page 300. The header tag is designated “INDEXON” and the trailer tag is designated “INDEXOFF”. As such, the author has tagged the page to direct a search engine, which has been instructed to search for tags, to index between the tags “INDEXON” and “INDEXOFF”. In a subsequent search, a searcher may want to index the page that contained specific tool related content. In this example, because this source is straight HTML, a custom hidden tag is generated. In other examples, the efficiency of the tagging can be increased if the source was XML based using a common document type definition (DTD). In this way, the author has directed a more efficient search that would only generate a hit for content that occurred within the tagged section of the DOM. In this particular search, the searcher is determining the number of users 315 for a particular tool. The author is avoiding hits outside of the tags (INDEXON as an index-on marker and INDEXOFF as an index-off).

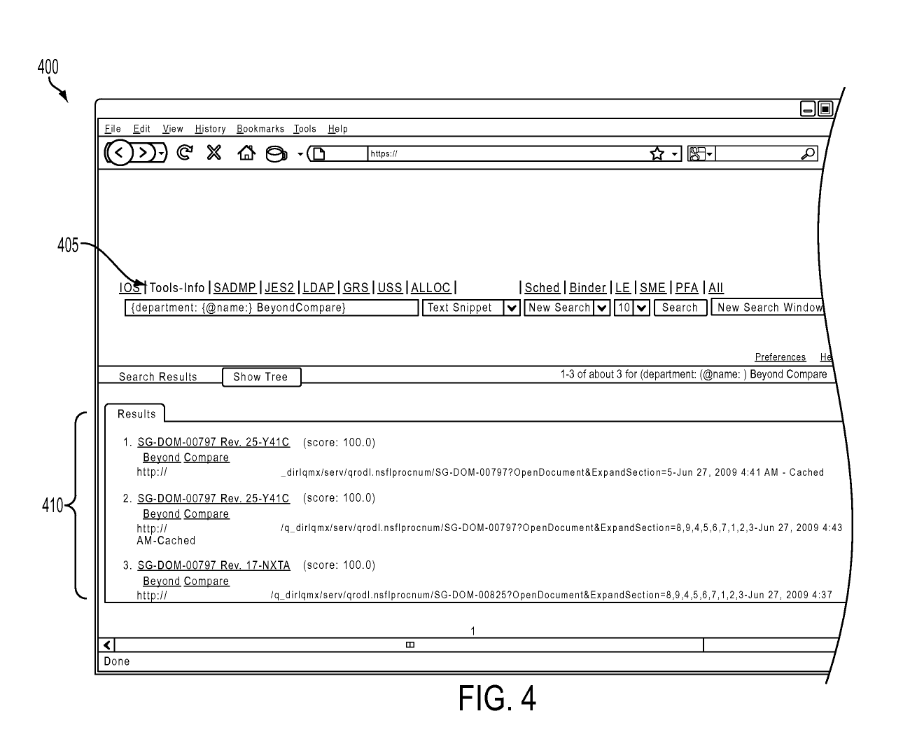

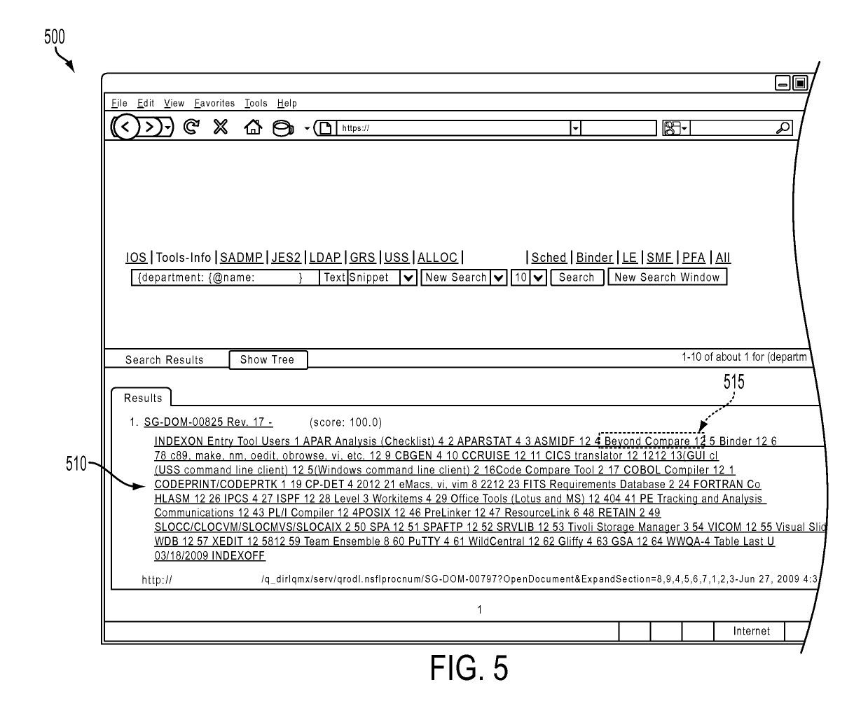

FIG. 4 illustrates a screenshot 400 of a search engine window. The searcher is searching for a tool “Beyond Compare”, the keywords for which the searcher entered into a search term field 405. This particular search yielded three results as displayed in the search results window 410. The third search result is the MXTA DOM. FIG. 5 illustrates a screen shot 500 of a search engine window after the user has selected the third search result illustrated in FIG. 4. The third search result is illustrated in the search result window 510, which shows the search term 515 within the search results. As such, the search engine indexed the content between the tags “INDEXON” and “INDEXOFF” originally set by the author of the DOM page 300 illustrated in FIG. 3. In the particular search of “Beyond Compare”, only the portion of the page 300 are indexed, which in the example results in a positive hit of the page 300.

As described herein, the example tags, “INDEXON” and “INDEXOFF”, are one example of the types of delimiter tags that can be implemented in accordance with exemplary embodiments. In the example, the search engine used a reference to the top-level URL to start the crawling process. In the example, the URL is listed in a directory in the Enterprise database. When the search engine found the page, it saw the tags and recognized that as a signal to do the “special indexing” with an awareness of the specifically hardcoded “INDEXON” and “INDEXOFF” tags to be used as specialty on/off indexing tags.

As further described herein, any type of tags can be implemented in accordance with exemplary embodiments. For example, an author can deposit a control tag within the up-front meta tags of an object which would be recognized by a compliant/adopting crawler/indexer. In another example, the author (or an aware edit utility) can define/deposit (document) unique indexing tags in the front meta-data to define to the crawler what would have been the equivalent tag names (analogous to the “INDEXON” and “INDEXOFF” tags in the example). As such, the up front meta tag information can include a “special indexing enabled” indicator along with the “tag definitions associated with “special indexing on” and “special indexing off”.

As described herein, the search engine indexing methods can be implemented for private networks, public networks such as the Internet and other networks such as Enterprise networks. The search engine indexing methods can also be implemented on any suitable computer system as now described.

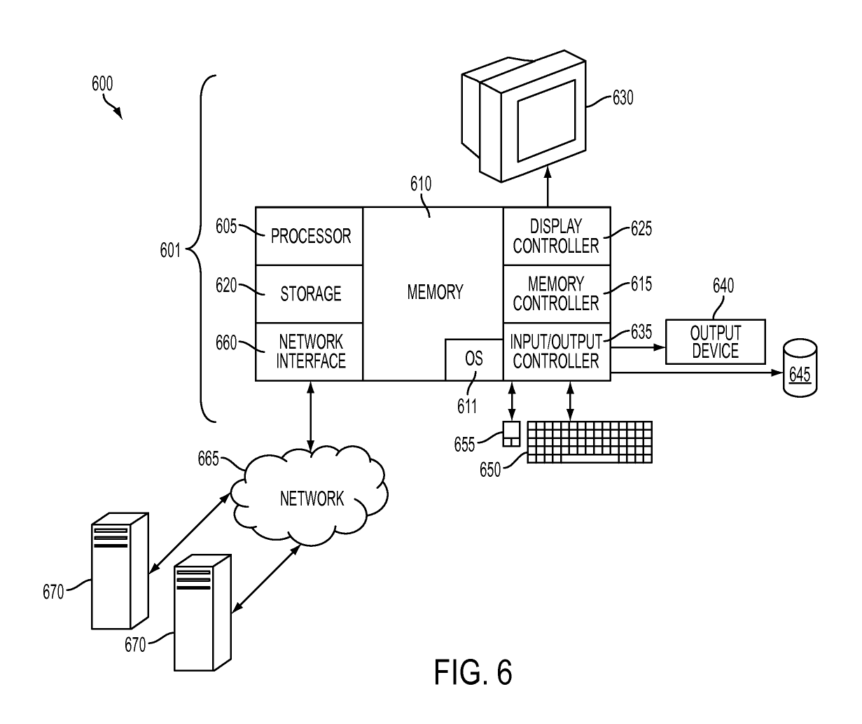

FIG. 6 illustrates an exemplary embodiment of a system 600 in which the exemplary search engine indexing methods described herein can be implemented. The methods described herein can be implemented in software (e.g., firmware) executing on hardware, pure hardware, or a combination thereof. In exemplary embodiments, the methods described herein are implemented in software, as an executable program, that is executed by a special- or general-purpose digital computer, such as a personal computer, workstation, minicomputer, or mainframe computer. The system 600 therefore includes general-purpose computer 601.

In exemplary embodiments, in terms of hardware architecture, as shown in FIG. 6, the computer 601 includes a processor 605, memory 610 coupled to a memory controller 615, and one or more input and/or output (I/O) devices 640, 645 (or peripherals) that are communicatively coupled via a local input/output controller 635. The input/output controller 635 can be, but is not limited to, one or more buses or other wired or wireless connections, as is known in the art. The input/output controller 635 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 605 is a hardware device for executing software, particularly that stored in memory 610. The processor 605 can be any custom made or commercially available processor, a central processing unit (CPU), an auxiliary processor among several processors associated with the computer 601, a semiconductor based microprocessor (in the form of a microchip or chip set), a macroprocessor, or generally any device for executing software instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 610 may incorporate electronic, magnetic, optical, and/or other types of storage media. Note that the memory 610 can have a distributed architecture, where various components are situated remote from one another, but can be accessed by the processor 605.

The software in memory 610 may include one or more separate programs, each of which comprises an ordered listing of executable instructions for implementing logical functions. In the example of FIG. 6, the software in the memory 610 includes the search engine indexing methods described herein in accordance with exemplary embodiments and a suitable operating system (OS) 611. The operating system 611 essentially controls the execution of other computer programs, such the search engine indexing systems and methods as described herein, and provides scheduling, input-output control, file and data management, memory management, and communication control and related services.

The search engine indexing methods described herein may be in the form of a source program, executable program (object code), script, or any other entity comprising a set of instructions to be performed. When a source program, then the program needs to be translated via a compiler, assembler, interpreter, or the like, which may or may not be included within the memory 610, so as to operate properly in connection with the OS 611. Furthermore, the search engine indexing methods can be written as an object oriented programming language, which has classes of data and methods, or a procedural programming language, which has routines, subroutines, and/or functions.

In exemplary embodiments, a conventional keyboard 650 and mouse 655 can be coupled to the input/output controller 635. Other output devices such as the I/O devices 640, 645 may include input devices, for example but not limited to a printer, a scanner, microphone, and the like. Finally, the I/O devices 640, 645 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 600 can further include a display controller 625 coupled to a display 630. In exemplary embodiments, the system 600 can further include a network interface 660 for coupling to a network 665. The network 665 can be an IP-based network for communication between the computer 601 and any external server, client and the like via a broadband connection. The network 665 transmits and receives data between the computer 601 and external systems. In exemplary embodiments, network 665 can be a managed IP network administered by a service provider. The network 665 may be implemented in a wireless fashion, e.g., using wireless protocols and technologies, such as WiFi, WiMax, etc. The network 665 can also be a packet-switched network such as a local area network, wide area network, metropolitan area network, Internet network, or other similar type of network environment. The network 665 may be a fixed wireless network, a wireless local area network (LAN), a wireless wide area network (WAN) a personal area network (PAN), a virtual private network (VPN), intranet or other suitable network system and includes equipment for receiving and transmitting signals. Several servers 670 can be communicatively coupled to the network 665. The servers 670 can include pages that can be searched and indexed in accordance with the exemplary search engine indexing methods described herein.

If the computer 601 is a PC, workstation, intelligent device or the like, the software in the memory 610 may further include a basic input output system (BIOS) (omitted for simplicity). The BIOS is a set of essential software routines that initialize and test hardware at startup, start the OS 611, and support the transfer of data among the hardware devices. The BIOS is stored in ROM so that the BIOS can be executed when the computer 601 is activated.

When the computer 601 is in operation, the processor 605 is configured to execute software stored within the memory 610, to communicate data to and from the memory 610, and to generally control operations of the computer 601 pursuant to the software. The search engine indexing methods described herein and the OS 611, in whole or in part, but typically the latter, are read by the processor 605, perhaps buffered within the processor 605, and then executed.

When the systems and methods described herein are implemented in software, as is shown in FIG. 6, the methods can be stored on any computer readable medium, such as storage 620, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) except for the general-purpose hardware on which such software executes, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the search engine indexing methods are implemented in hardware, the search engine indexing methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include increased focus of the indexing of search engine searching, reducing the size of index storage, allowing for faster and more efficient searches due to the reduced content within the index itself. Technical effects further include reduction the number of false positives from subsequent searches and a reduction in search/data mining CPU cycles when using the focused index or sub-index.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A search engine indexing method, comprising:
finding a page on a server that includes keywords;
scanning the page for a tag designating a portion of the page from which to index the keywords; and
in response to a presence of the tag within the page, indexing the portion of the page that is designated by the tag.

2. The method as claimed in claim 1 further comprising, in response to an absence of the tags in the page, reading a first N bytes of the page to locate the keywords.

3. The method as claimed in claim 1 wherein the page includes a header tag and a trailer tag.

4. The method as claimed in claim 3 wherein the page is indexed between the header tag and the trailer tag.

5. The method as claimed in claim 4 wherein the header tag and a trailer tag enclose a designated portion of data on the page.

6. The method as claimed in claim 1 wherein the page is indexed from the data after the tag to a clip limit.

7. The method as claimed in claim 1 further comprising, in response to determining the presence of tags in the page, searching for keywords designated by the tag.

8. A web page generation method, comprising:
generating electronic content in the web page;
identifying a portion of the electronic content to be indexed by a web crawler; and
designating the portion of the electronic content to be indexed by the web crawler with a header tag and a trailer tag,
wherein the header tag and the trailer tag designate the portion of electronic content to be indexed by the web crawler.

9. The method as claimed in claim 8 further comprising placing the web page on a server and designating the web page as searchable by the web crawler.
